(19) United States
(12) Patent Application Publication
(10) Pub. No.: US 2025/0077711 A1
(43) Pub. Date: Mar. 6, 2025

(54) LOCK STATE BASED ON A TRIGGER CONDITION

(71) Applicant: Motorola Mobility LLC, Chicago, IL (US)

(72) Inventors: Ranjeet Gupta, Naperville, IL (US); Hua Zhang, Hinsdale, IL (US); Amit Kumar Agrawal, Bangalore (IN)

(73) Assignee: Motorola Mobility LLC, Chicago, IL (US)

(21) Appl. No.: 18/241,504

(22) Filed: Sep. 1, 2023

(51) Int. Cl. G06F 21/62; G06F 21/70

(52) U.S. Cl. CPC G06F 21/629; G06F 21/70; H04W 12/67

(57) ABSTRACT

Techniques for lock state based on a trigger condition are described and may be implemented to transition a mobile device to a locked state based on various conditions. For instance, a mobile device receives transmission of cloud content and transmits the cloud content to a connected remote display device for output. A trigger condition occurs based on the transmission of the cloud content, such as a decrease in data transmission related to the cloud content. The mobile device can transition to a locked state based at least in part on the trigger condition.

### BACKGROUND

Today's person is afforded a tremendous selection of devices that are capable of performing a multitude of tasks. For instance, desktop and laptop computers provide computing power and screen space for productivity and entertainment tasks. Further, smartphones and tablets provide computing power and communication capabilities in highly portable form factors. Many people have access to multiple different devices and use of a particular device depends on the person's current status, such as on the go, in the office, at home, and so forth. While individual instances of devices provide functionality for discrete sets of tasks, the ability for devices to intercommunicate with one another greatly expands available task options and operating environments. For instance, a typical smartphone is able to wirelessly cast visual content to a larger screen device to enable enhanced enjoyment of the content.

While the ability for devices to intercommunicate provides for numerous usage scenarios it also introduces challenges when it comes to device security and particularly when different devices utilize different security settings.

### BRIEF DESCRIPTION OF THE DRAWINGS

Aspects of lock state based on a trigger condition are described with reference to the following Figures. The same numbers may be used throughout to reference similar features and components that are shown in the Figures. Further, identical numbers followed by different letters reference different instances of features and components described herein:

FIG. 1 illustrates an example environment in which aspects of lock state based on a trigger condition can be implemented.

FIG. 2 depicts an example system for implementing aspects of lock state based on a trigger condition in accordance with one or more implementations.

FIG. 3 depicts an example system for implementing aspects of lock state based on a trigger condition in accordance with one or more implementations.

FIG. 4 illustrates a flow chart depicting an example method for lock state based on a trigger condition in accordance with one or more implementations.

FIG. 5 illustrates a flow chart depicting an example method for lock state based on a trigger condition in accordance with one or more implementations.

FIG. 6 illustrates various components of an example device in which aspects of lock state based on a trigger condition can be implemented.

### DETAILED DESCRIPTION

Techniques for lock state based on a trigger condition are described and may be implemented to control a lock state of a mobile device based on different trigger conditions. The described implementations, for instance, enable a mobile device that is streaming cloud data to be transitioned to a locked state when data activity is reduced, e.g., below a threshold amount of data. This can provide for increased device security as compared to conventional techniques for network content streaming.

For instance, consider a scenario where a mobile device (e.g., a smartphone) is connected to a display device that is external to the mobile device. The mobile device and the display device, for example, are able to intercommunicate, such as via wireless and/or wired connectivity. Further, the mobile device can connect to a cloud service (e.g., a network resource) to obtain cloud content. In at least one example the cloud service exposes computational resources to the mobile device, such as cloud computing resources. Thus, the cloud content can include content generated via the cloud computing resources and transmitted to the mobile device, such as part of a cloud PC experience. The mobile device can transmit the cloud content to the connected display device for visual and/or audible output. Further, a user can interact with the cloud content displayed on the connected display device. For instance, one or more input devices can be connected to the mobile device (e.g., via wireless and/or wired connectivity) and the user can utilize the connected input devices to interact with the cloud content.

Further to the described implementations, consider that while the mobile device is transmitting the cloud content to the connected display device, an event occurs that causes a display device of the mobile device to power down, e.g., dim and/or turn off. For instance, while the user is interacting via the mobile device with the cloud content displayed on the connected display device, the mobile device's display device times out and powers down. In implementations the mobile device remains unlocked while the mobile device's display device is powered down to enable continued user interaction with the cloud content displayed on the connected display device.

Continuing with this scenario, consider that the cloud content provided from the cloud service to the mobile device and displayed on the connected display transitions to an inactive state. For instance, a user may lock cloud computing resources and/or the cloud computing resources may time out due to user inactivity and enter a locked state. In implementations the connected display can reflect the inactive state of the cloud computing resources, such as by displaying a lock screen on the connected display. In some conventional implementations and while the cloud computing resources may be inactive, the mobile device may remain in an unlocked state, e.g., an active state where some or all functionality of the mobile device is exposed without requiring additional authentication. For instance, even though a display screen of the mobile device may be inactive while cloud content on the connected displayed is locked, the mobile device itself may remain unlocked such that the mobile device can be accessed without being unlocked, e.g., without further authentication.

Accordingly, implementations described herein enable the mobile device to be transitioned to a locked state when such situations occur. For instance, when cloud content transmitted to a mobile device and then streamed to a connected display becomes inactive, a trigger condition can occur that causes the mobile device to transition from an unlocked state to a locked state. The trigger condition, for instance, can be based on an amount of data transmitted from the cloud service to the mobile device over a time duration and/or an amount of data transmitted from the mobile device to the cloud service over a time duration. For example, when the cloud content becomes inactive, data transmission from the cloud service to the mobile device can fall below a threshold amount of data over a threshold period of time. For instance, data transmission from the cloud service to the mobile device can be reduced to zero (e.g., no data transmission) for the threshold period of time. In response, the mobile device can transition from an unlocked state to a locked state to secure the mobile device from unauthorized access.

In at least some implementations a cloud service can enable a mobile device to transition to a locked state in response to a change in data transmission between the cloud service and the mobile device. For instance, where a user pauses interaction with the mobile device, data transmission from the mobile device to the cloud service can fall below a threshold amount of data over a threshold time duration. Alternatively or additionally a user can transition cloud computing resources to a locked state. Accordingly, the cloud service can transmit a notification to the mobile device to transition to a locked state. The mobile device can receive the notification and transition from an unlocked state to a locked state.

The techniques described herein thus enable protection of a mobile device in different scenarios, such as when cloud content is transmitted to the mobile device and transmitted from the mobile device to a connected display device. For instance, when the cloud content enters a timed-out and/or locked state, a trigger event can cause the mobile device to transition to a locked state. This provides for increased device security such as by mitigating the risk of unauthorized access to mobile device resources such as data and functionality.

While features and concepts of lock state based on a trigger condition can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

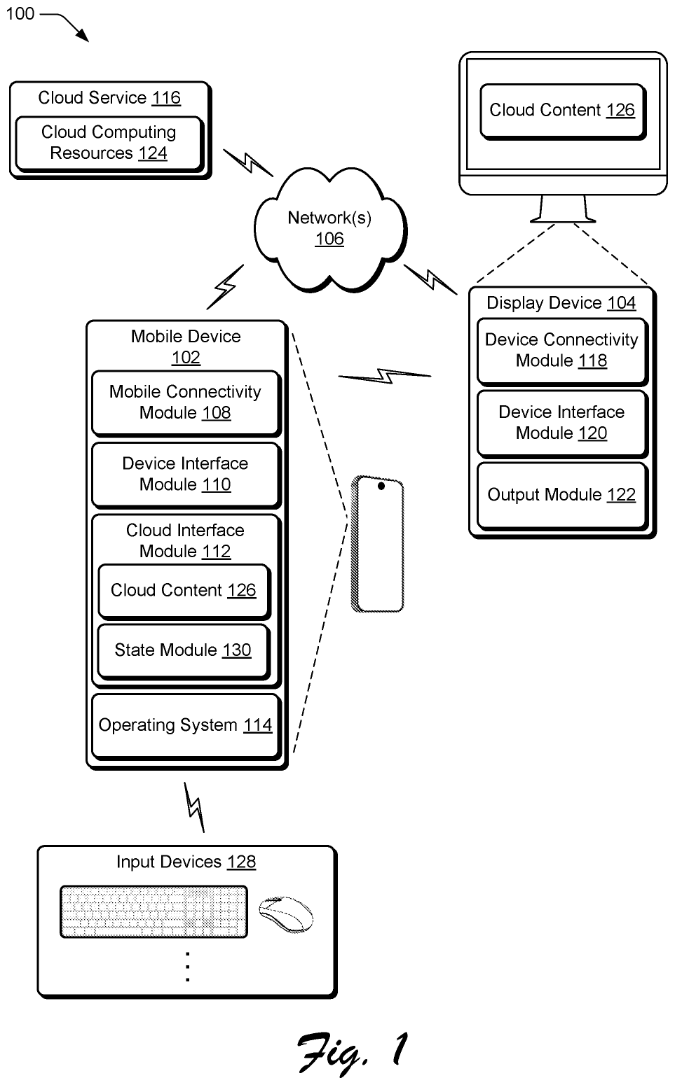

FIG. 1 illustrates an example environment 100 in which aspects of lock state based on a trigger condition can be implemented. The environment 100 includes a mobile device 102 and a display device 104 that are interconnectable in various ways to enable content from the mobile device 102 to be displayed by the display device 104. The mobile device 102 and the display device 104, for instance, are interconnectable via a network 106 and/or via direct inter-device connectivity, e.g., via direct wireless and/or wired connectivity between the mobile device 102 and the display device 104. In this particular example, the mobile device 102 represents a portable device that can be carried by a user, such as a smartphone, a tablet device, a wearable device, an extended reality (XR) device, etc.

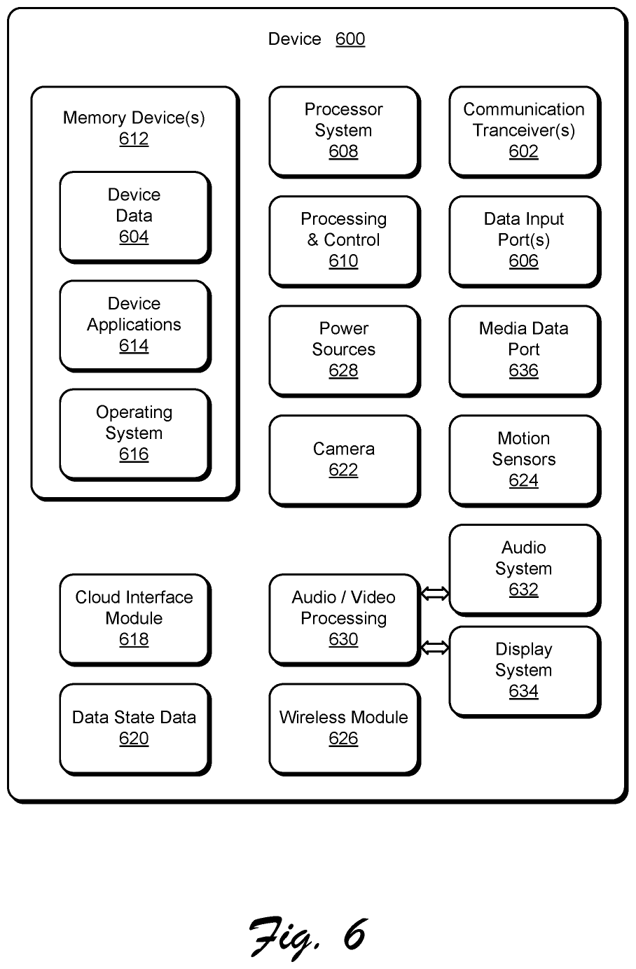

The display device 104 represents functionality for various types of content output, such as output of visual and audible content. The display device 104 can be implemented in various ways, such as a television (e.g., a smart TV), a display panel, a projector display, a computing device with an associated display device, and so forth. In at least one implementation the display device 104 represents a dedicated display device configured to output visual content generated by other devices, such as content generated at the mobile device 102 and transmitted to the display device 104 for display. Alternatively or additionally the display device 104 includes computing functionality, such as discussed with reference to the device 600. These examples are not to be construed as limiting, however, and the mobile device 102 and/or the display device 104 can be implemented in a variety of different ways and form factors. Example attributes of the mobile device 102 and the display device 104 are discussed below with reference to the device 600 of FIG. 6.

The mobile device 102 includes various functionality that enables the mobile device 102 to perform different aspects of lock state based on a trigger condition discussed herein, including a mobile connectivity module 108, a device interface module 110, a cloud interface module 112, and an operating system 114. The mobile connectivity module 108 represents functionality (e.g., logic and hardware) for enabling the mobile device 102 to interconnect with other devices and/or networks, such as the display device 104 and the network 106. The mobile connectivity module 108, for instance, enables wireless and/or wired connectivity of the mobile device 102.

The device interface module 110 represents functionality for enabling the mobile device 102 to interface with other devices. As further detail below, for instance, the device interface module 110 enables the mobile device 102 to establish wireless and/or wired data communication with other devices, e.g., the display device 104. The cloud interface module 112 represents functionality to enable the mobile device 102 to access functionality of different cloud services via access to the network 106, including a cloud service 116. The operating system 114 represents functionality to manage various resources of the mobile device 102 (e.g., hardware and software resources) and can provide common services for computer programs (e.g., applications) of the mobile device 102.

The display device 104 includes various functionality that enables the display device 104 to perform different aspects of lock state based on a trigger condition discussed herein, including a device connectivity module 118, a device interface module 120, and an output module 122. The device connectivity module 118 represents functionality (e.g., logic and hardware) for enabling the display device 104 to interconnect with other devices and/or networks, such as the mobile device 102 and the network 106. The device connectivity module 118, for instance, enables wireless and/or wired connectivity of the display device 104.

For instance, the mobile device 102 and the display device 104 can interconnect via wired connectivity, such as via universal serial bus (USB) wired connectivity, e.g., via a USB supported display port. In wireless scenarios the mobile device 102 and the display device 104 can be configured to intercommunicate via a variety of different wireless protocols, such as ultra-wideband (UWB), wireless broadband, Wireless Local Area Network (WLAN) (e.g., Wi-Fi), Wi-Fi Direct, wireless short distance communication (e.g., Bluetooth™ (including Bluetooth™ Low Energy (BLE)), Near Field Communication (NFC)), and so forth.

The device interface module 120 is representative of functionality for enabling the display device 104 to interface with other devices. For instance, the device interface module 120 interfaces with the device interface module 110 of the mobile device 102 to enable collaborative data communication between the display device 104 and the mobile device 102. The output module 122 represents functionality for enabling content to be output by the display device 104, such as visual content and audible content. The output module 122, for instance, includes a display driver, an audio driver, and/or other logic and hardware for outputting content by the display device 104.

According to implementations for lock state based on a trigger condition, the cloud interface module 112 can interface with the cloud service 116 to access cloud computing resources 124 to perform various computation tasks. The cloud computing resources 124, for instance, represent computer system resources that reside at one or more network locations, such as data storage (e.g., cloud storage), data processing resources, software resources such as applications, and so forth. In implementations the cloud computing resources 124 represent distributed computing resources that may reside at different network locations and that are accessible to the mobile device 102 via the cloud service 116.

Further to the environment 100, the mobile device 102 can obtain cloud content 126 from the cloud computing resources 124 and transmit the cloud content 126 to the display device 104 for output. The cloud content 126, for example, can represent various types and instances of computation-related content, such as a desktop computation experience that exposes different functionality such as applications and services. Alternatively or additionally the cloud content 126 can represent other types of computation-related content, such as digital gaming, entertainment, educational content, etc. In at least some implementations the cloud content 126 is transmitted from the mobile device 102 to the display device 104 via interaction between the device interface module 110 and the device interface module 120.

Input devices 128 are also depicted as part of the environment 100 and represent functionality to enable a user to provide input to the mobile device 102 such as for interacting with the cloud content 126. For instance, the input devices 128 enable manipulation of the cloud content 126 to perform various computation tasks. Examples of the input devices 128 include a keyboard, a mouse, a game controller, a remote content control, an extend reality (XR) device, etc. Further, the input devices 128 may connect with the mobile device 102 via wireless and/or wired connectivity.

The cloud interface module 112 also includes and/or has access to a state module 130, which represents functionality to perform various aspects of lock state based on a trigger condition. The state module 130, for instance, can monitor different states of the mobile device 102 and the cloud content 126 to determine whether to transition the mobile device 102 to a locked state. For example, the state module 130 can detect different state conditions (e.g., data state conditions) that indicate that the mobile device 102 is to transition from an unlocked state to a locked state, and can signal the operating system 114 to place the mobile device 102 in a locked state. As further detailed herein, for example, the state module 130 can detect that data activity (e.g., packet transmission) between the cloud computing resources 124 and the mobile device 102 falls below a threshold activity level for a threshold time duration, which can indicate that the cloud computing resources 124 are in a locked state, e.g., have timed out. Accordingly, in response the state module 130 can signal the operating system 114 to transition the mobile device 102 to a locked state, e.g., to activate a lock screen of the mobile device 102.

Having discussed an example environment in which the disclosed techniques can be performed, consider now some example scenarios and implementation details for implementing the disclosed techniques.

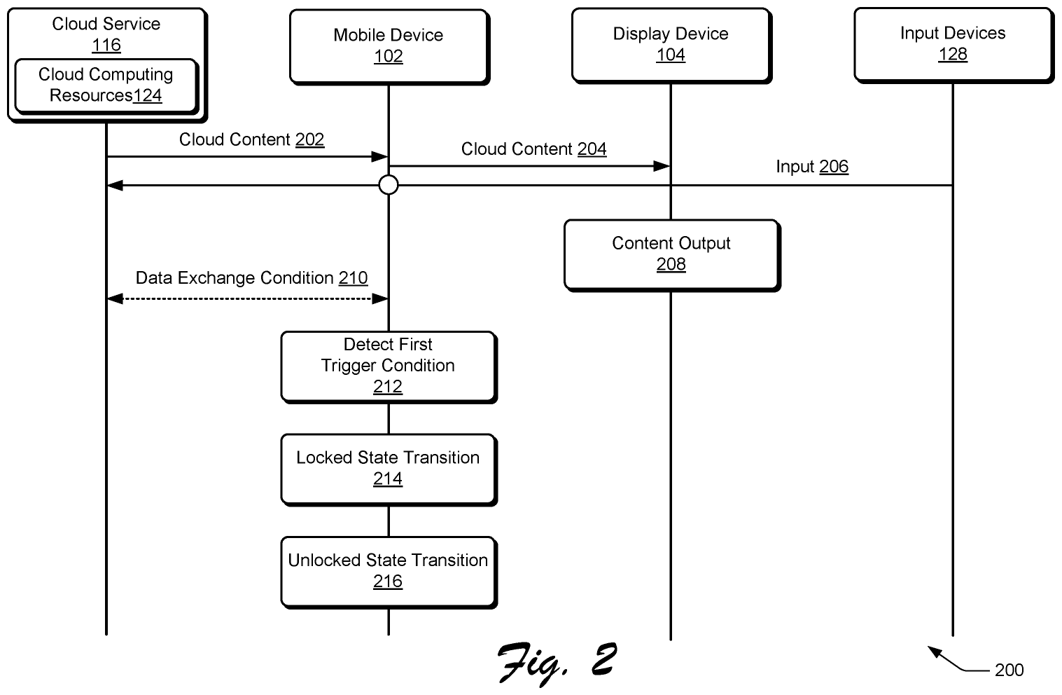

FIG. 2 depicts an example system 200 for implementing aspects of lock state based on a trigger condition in accordance with one or more implementations. The system 200 can be implemented in the environment 100 and incorporates attributes of the environment 100 introduced above.

In the system 200 the cloud service 116 transmits cloud content 202 to the mobile device 102. The cloud content 202, for instance, represents content generated via the cloud computing resources 124. Accordingly, based at least in part on the cloud content 202, the mobile device 102 transmits cloud content 204 to the display device 104. In implementations the cloud content 204 can represent an unmodified version of the cloud content 202 or may represent a modified version of the cloud content 202. For instance, the mobile device 102 may perform processing on the cloud content 202 to generate the cloud content 204.

Further, the input devices 128 may provide input 206 to the mobile device 102 to interact with (e.g., manipulate) the cloud content 202 and/or the cloud content 204. For instance, the input 206 can be transmitted from the mobile device 102 to the cloud service 116 to enable interaction with the cloud computing resources 124. Accordingly, the display device 104 can perform content output 208 to output (e.g., visually and/or audibly) the cloud content 204.

Based at least in part on a data exchange condition 210 between the cloud service 116 and the mobile device 102, at 212 the mobile device 102 detects a first trigger condition. For example, the first trigger condition is based on a determination that an amount of data received at the mobile device 102 from the cloud service 116 falls below a first threshold amount of data over a first threshold time duration. In implementations the first trigger condition may occur when the cloud computing resources 124 are placed in a locked state such that an amount of data generated by and/or pertaining to the cloud computing resources 124 and transmitted from the cloud service 116 to the mobile device 102 is reduced to below the first threshold amount of data.

Alternatively or additionally the first trigger condition can be based on a determination that an amount of data transmitted from the mobile device 102 to the cloud service 116 falls below a second threshold amount of data over a second threshold time duration. For instance, the first trigger condition may occur when a user stops interacting with the mobile device 102 for the second threshold time duration, such as when the user steps away to perform other tasks, take a break, etc.

In at least some implementations determining an amount of data exchanged (e.g., transmitted and/or received) can be based on data packets (e.g., user data, data plane data, etc.) and not control packets, e.g., control data, control plane data, etc. This is not intended to be limiting, however, and some implementations may consider both data packets and control packets. Further, a threshold amount of data can be defined in different ways, such as packet rate (e.g., packets per second), bit rate, data rate, etc. Still further, a threshold time duration can be defined in different ways, such as in seconds, minutes, etc.

Further to the system 200 and based at least in part on the first trigger condition, the mobile device 102 performs a locked state transition 214. The mobile device 102, for instance, transitions from an unlocked state to a locked state. After the locked state transition 214 the mobile device 102 may perform an unlocked state transition 216 to transition the mobile device 102 from the locked state to an unlocked state. The unlocked state transition 216, for instance, is performed in response to user authentication with the mobile device 102.

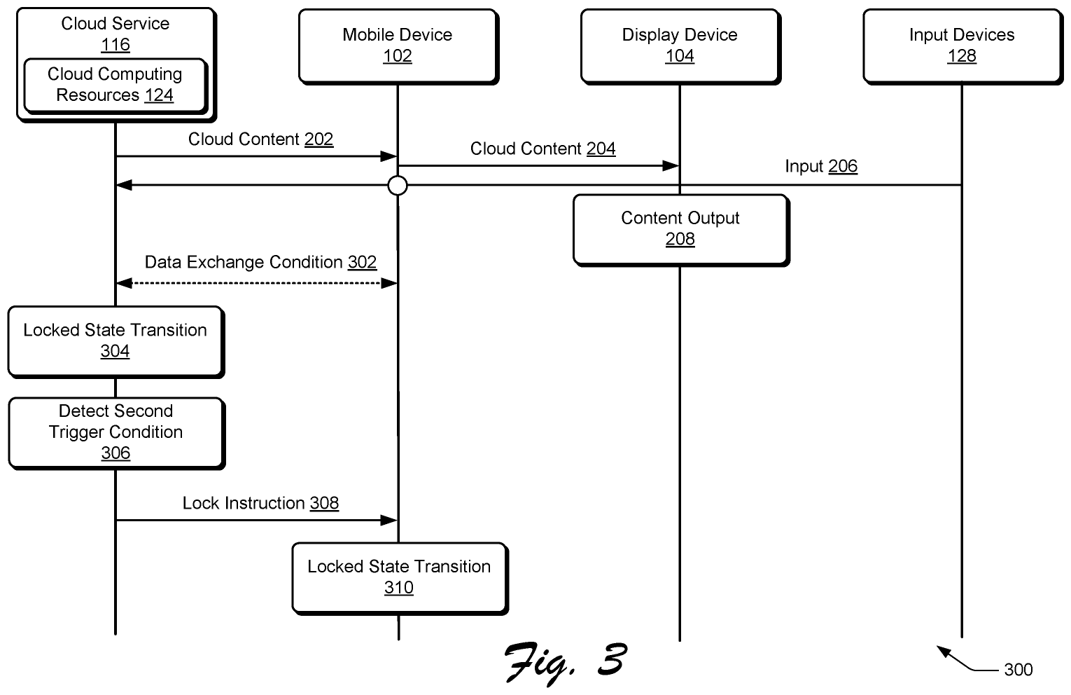

FIG. 3 depicts an example system 300 for implementing aspects of lock state based on a trigger condition in accordance with one or more implementations. The system 300 can be implemented in the environment 100 and incorporates attributes of the environment 100 introduced above. Further, the system 300 can represent an alternative or additional implementation to the system 200.

In the system 300 and as discussed above with reference to the system 200, the cloud service 116 transmits the cloud content 202 to the mobile device 102 and the mobile device 102 transmits the cloud content 204 to the display device 104. The display device 104 can perform content output 208 to output the cloud content 204. Further, the input devices 128 can be utilized to provide input 206 to interact with the cloud computing resources 124, the cloud content 202, and/or the cloud content 204.

Further to the system 300 a data exchange condition 302 occurs based on data transmission from the cloud service 116 to the mobile device 102 and/or based on data reception at the cloud service 116 of data transmitted from the mobile device 102. The data exchange condition 302, for instance, can be based on an amount of data exchanged between the cloud service 116 and the mobile device 102, such as data transmitted by the cloud service 116 to the mobile device 102 and/or data transmitted by the mobile device 102 to the 116.

Alternatively or additionally the cloud computing resources 124 can perform a locked state transition 304 where the cloud computing resources 124 are transitioned from an unlocked state to a locked state. For instance and utilizing the input 206, a user can interact with the cloud computing resources 124 to instruct that the cloud computing resources 124 to transition to a locked state. Alternatively or additionally the cloud computing resources 124 can transition to a locked state after a period of inactivity, e.g., where the cloud computing resources 124 stop receiving data from the mobile device 102 for a timeout period.

Accordingly, at 306 the cloud service 116 detects a second trigger condition. The second trigger condition, for instance, is based on a determination that an amount of data transmitted from the cloud service 116 to the mobile device 102 falls below a third threshold amount of data over a third threshold time duration. In implementations the second trigger condition may occur when the cloud computing resources 124 are placed in a locked state such that an amount of data generated by and/or pertaining to the cloud computing resources 124 and transmitted from the cloud service 116 to the mobile device 102 is reduced to below the third threshold amount of data over the third threshold time duration.

Alternatively or additionally the second trigger condition can be based on a determination that an amount of data received at the cloud service 116 from the mobile device 102 falls below a fourth threshold amount of data over a fourth threshold time duration. For instance, the second trigger condition may occur when a user stops interacting with the mobile device 102 for the fourth threshold time duration, such as when the user steps away to perform other tasks, take a break, etc.

Alternatively or additionally the second trigger condition can be based on the locked state transition 304. For example, the second trigger condition can occur when the mobile device 102 instructs the cloud computing resources 124 to perform the locked state transition 304.

Accordingly, based at least in part on the second trigger condition, the cloud service 116 transmits a lock instruction 308 to the mobile device 102 instructing the mobile device 102 to transition to a locked state. In response to the lock instruction 308 the mobile device 102 may perform a locked state transition 310 to transition the mobile device 102 from an unlocked state to a locked state. Alternatively, if the mobile device 102 is already in a locked state when the lock instruction 308 is received (e.g., as described with reference to the system 200), the mobile device 102 may ignore the lock instruction 308.

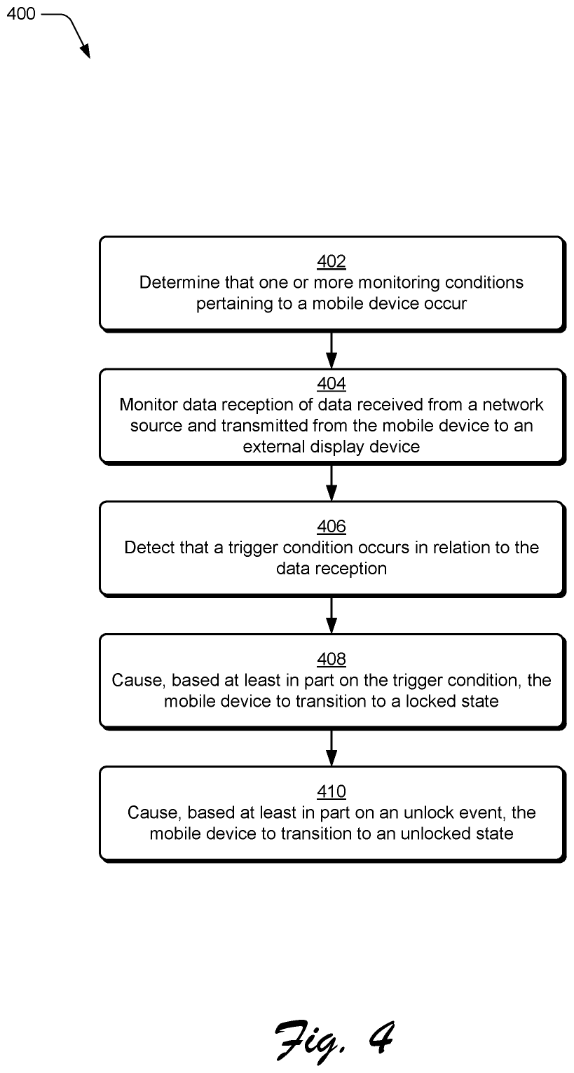

FIG. 4 illustrates a flow chart depicting an example method 400 for lock state based on a trigger condition in accordance with one or more implementations. The method 400, for example, may be implemented by the mobile device 102.

At 402 it is determined that one or more monitoring conditions pertaining to a mobile device occur. The monitoring conditions, for instance, pertain to different state conditions of the mobile device 102. Examples of the monitoring conditions include at least one of that the mobile device 102 is connected to the display device 104 via at least one of a wired connection or a wireless connection, that the mobile device 102 is connected to a data network (e.g., the network 106) such that the mobile device 102 can stream data from the data network, that the mobile device 102 is streaming cloud content to the display device 104 such as from the cloud computing resources 124, that the mobile device 102 is not utilized as an input device for providing input to data transmitted from the mobile device 102 to the display device 104, that one or more input devices 128 are connected to the mobile device 102 for providing input to content (e.g., cloud content) transmitted from the mobile device 102 to the display device 104, and so forth.

At 404 data reception is monitored of data received from a network source and transmitted from the mobile device to an external display device. In implementations the cloud interface module 112 can monitor the data reception in response to determining that one or more of the monitoring conditions occur. The cloud interface module 112, for instance, monitors attributes of data transmitted by the cloud service 116 to the mobile device 102, such as data including cloud content pertaining to the cloud computing resources 124. Monitoring the data can include monitoring an amount of data received over a time duration.

At 406 it is detected that a trigger condition occurs in relation to the data reception. Examples of different trigger conditions are described herein, such as an indication that the data reception falls below a threshold amount of data received at the mobile device 102 from the cloud service 116 over a threshold time duration. In implementations the threshold amount of data and/or the threshold time duration are user configurable. Alternatively or additionally the threshold amount of data and/or the threshold time duration can be configured based on a determined location of the mobile device 102. For instance, a lower threshold amount of data and/or a shorter threshold time duration may be specified at an unknown and/or unsecure location (e.g., a public location and/or a known unsecure location) than at a known secure location, e.g., a user's home, office, etc.

At 408 and based at least in part on the trigger condition, the mobile device is caused to transition to a locked state. The cloud interface module 112, for instance, instructs the operating system 114 to transition the mobile device 102 from an unlocked state to a locked state. Accordingly, the operating system 114 can transition the mobile device 102 from an unlocked state to a locked state where some or all functionality (e.g., applications, services, etc.) of the mobile device 102 is inaccessible.

At 410 and based at least in part on an unlock event, the mobile device is caused to transition to an unlocked state. A user, for instance, performs an unlock action on the mobile device 102 (e.g., presses a button, touches a touch screen, etc.) and authenticates with the mobile device 102 to cause the mobile device 102 to transition from the locked state to an unlocked state where functionality of the mobile device 102 is accessible.

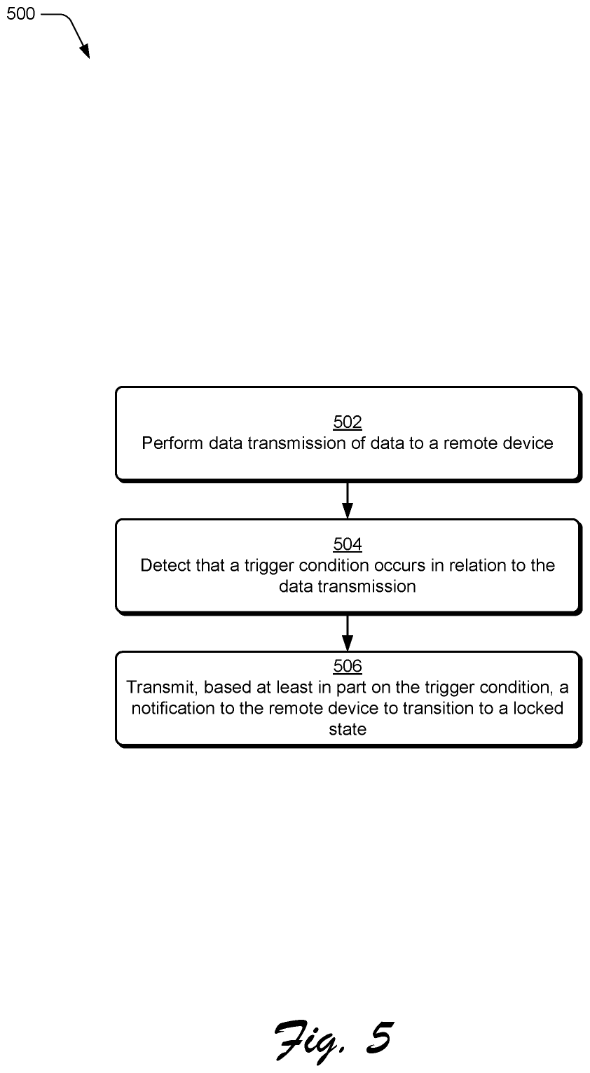

FIG. 5 illustrates a flow chart depicting an example method 500 for lock state based on a trigger condition in accordance with one or more implementations. The method 500, for example, may be implemented by the cloud service 116.

At 502 data transmission is performed of data to a remote device. The cloud service 116, for example, transmits data (e.g., cloud content) pertaining to the cloud computing resources 124 to the mobile device 102. At 504 it is detected that a trigger condition occurs in relation to the data transmission. For instance, the cloud service 116 detects that a trigger condition pertaining to data transmission to the mobile device 102 occurs. In at least one example the trigger condition is based at least in part on an indication that data transmission from the cloud service 116 to the mobile device 102 falls below a threshold amount of data over a threshold time duration. Alternatively or additionally the trigger condition is based at least in part on an indication that data reception at the cloud service 116 from the mobile device 102 falls below a threshold amount of data over a threshold time duration. As another example the trigger condition is based on the cloud computing resources 124 being transitioned to a locked state.

At 506 and based at least in part on the trigger condition, a notification is transmitted to the remote device to transition to a locked state. For instance, based at least in part on the trigger condition, the cloud service 116 transmits a notification to the mobile device 102 to transition the mobile device 102 to a locked state. Accordingly, the mobile device 102 can transition from an unlocked state to a locked state.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 6 illustrates various components of an example device 600 in which aspects of lock state based on a trigger condition can be implemented. The example device 600 can be implemented as any of the devices described with reference to the previous FIGS. 1-5, such as any type of mobile device, mobile phone, mobile device, wearable device, tablet, computing, communication, entertainment, gaming, media playback, and/or other type of electronic device. For example, the mobile device 102 and/or the display device 104 as shown and described with reference to FIGS. 1-5 may be implemented as the example device 600.

The device 600 includes communication transceivers 602 that enable wired and/or wireless communication of device data 604 with other devices. The device data 604 can include any of device identifying data, device location data, wireless connectivity data, and wireless protocol data. Additionally, the device data 604 can include any type of audio, video, and/or image data. Example communication transceivers 602 include wireless personal area network (WPAN) radios compliant with various IEEE 802.15 (Bluetooth™) standards, wireless local area network (WLAN) radios compliant with any of the various IEEE 802.11 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processing system 608 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 610. The device 600 may further include any type of a system bus or other data and command transfer system that couples the various components within the device. A system bus can include any one or combination of different bus structures and architectures, as well as control and data lines.

The device 600 also includes computer-readable storage memory 612 (e.g., memory devices) that enable data storage, such as data storage devices that can be accessed by a computing device, and that provide persistent storage of data and executable instructions (e.g., software applications, programs, functions, and the like). Examples of the computer-readable storage memory 612 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory 612 provides data storage mechanisms to store the device data 604, other types of information and/or data, and various device applications 614 (e.g., software applications). For example, an operating system 616 can be maintained as software instructions with a memory device and executed by the processing system 608. The device applications may also include a device manager, such as any form of a control application, software application, signal-processing and control module, code that is native to a particular device, a hardware abstraction layer for a particular device, and so on. Computer-readable storage memory 612 represents media and/or devices that enable persistent and/or non-transitory storage of information in contrast to mere signal transmission, carrier waves, or signals per se. Computer-readable storage memory 612 do not include signals per se or transitory signals.

In this example, the device 600 includes a cloud interface module 618 that implements aspects of lock state based on a trigger condition and may be implemented with hardware components and/or in software as one of the device applications 614. For example, the cloud interface module 618 can be implemented as the cloud interface module 112 described in detail above. In implementations, the cloud interface module 618 may include independent processing, memory, and logic components as a computing and/or electronic device integrated with the device 600. The device 600 also includes data state data 620 for implementing aspects of lock state based on a trigger condition and may include data from the cloud interface module 618.

In this example, the example device 600 also includes a camera 622 and motion sensors 624, such as may be implemented in an inertial measurement unit (IMU). The motion sensors 624 can be implemented with various sensors, such as a gyroscope, an accelerometer, and/or other types of motion sensors to sense motion of the device. The various motion sensors 624 may also be implemented as components of an inertial measurement unit in the device.

The device 600 also includes a wireless module 626, which is representative of functionality to perform various wireless communication tasks. For instance, for the mobile device 62 and/or the display device 64, the wireless module 626 can be leveraged to scan for and detect wireless networks, as well as negotiate wireless connectivity to wireless networks for the mobile device 62 and/or the display device 64. Alternatively or additionally the wireless module 626 can enable direct device-to-device wireless connectivity between the mobile device 102 and the display device 104. The device 600 can also include one or more power sources 628, such as when the device is implemented as a mobile device. The power sources 628 may include a charging and/or power system, and can be implemented as a flexible strip battery, a rechargeable battery, a charged super-capacitor, and/or any other type of active or passive power source.

The device 600 also includes an audio and/or video processing system 630 that generates audio data for an audio system 632 and/or generates display data for a display system 634. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 636. In implementations, the audio system and/or the display system are integrated components of the example device. Alternatively, the audio system and/or the display system are external, peripheral components to the example device.

Although implementations of lock state based on a trigger condition have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In addition to the previously described methods, any one or more of the following:

In some aspects, the techniques described herein relate to a mobile device including: at least one processor; and at least one module executable by the at least one processor to: monitor data reception of data received from a network source and transmitted from the mobile device to an external display device; detect that a trigger condition occurs in relation to the data reception; and cause, based at least in part on the trigger condition, the mobile device to transition to a locked state.

In some aspects, the techniques described herein relate to a mobile device, wherein the at least one module is executable by the at least one processor to determine that the mobile device is connected to the external display device via at least one of a wired connection or a wireless connection.

In some aspects, the techniques described herein relate to a mobile device, wherein the at least one module is executable by the at least one processor to determine that the mobile device is not utilized as an input device for providing input to the data transmitted from the mobile device to the external display device.

In some aspects, the techniques described herein relate to a mobile device, wherein the at least one module is executable by the at least one processor to determine that at least one input device external to the mobile device is used as an input device for providing input to the data transmitted from the mobile device to the external display device.

In some aspects, the techniques described herein relate to a mobile device, wherein the at least one module is executable by the at least one processor to monitor the data reception based at least in part on whether the data reception occurs via wired connectivity or wireless connectivity to the network source.

In some aspects, the techniques described herein relate to a mobile device, wherein the trigger condition includes an indication that the data reception falls below a threshold amount of data received from the network source.

In some aspects, the techniques described herein relate to a mobile device, wherein the trigger condition further includes an indication that the data reception falls below the threshold amount of data received from the network source for a threshold time duration.

In some aspects, the techniques described herein relate to a mobile device, wherein the at least one module is executable by the at least one processor to enable at least one of the threshold amount of data or the threshold time duration to be user configurable.

In some aspects, the techniques described herein relate to a mobile device, wherein the at least one module is executable by the at least one processor to enable at least one of the threshold amount of data or the threshold time duration to be configured based on a location of the mobile device.

In some aspects, the techniques described herein relate to a mobile device, wherein the trigger condition includes an indication that data transmission from the mobile device to the network source falls below a threshold amount of data transmitted from the mobile device to the network source for a threshold time duration.

In some aspects, the techniques described herein relate to a method, including: monitoring data reception of data received at a mobile device from a network source and transmitted from the mobile device to an external display device; detecting that a trigger condition occurs in relation to the data reception; and causing, based at least in part on the trigger condition, the mobile device to transition to a locked state.

In some aspects, the techniques described herein relate to a method, wherein the trigger condition includes an indication that the data reception falls below a threshold amount of data received from the network source for a threshold time duration.

In some aspects, the techniques described herein relate to a method, wherein one or more of the threshold amount of data or the threshold time duration are least one of user configurable or based on a location of the mobile device.

In some aspects, the techniques described herein relate to a method, wherein the trigger condition includes an indication that data transmission from the mobile device to the network source falls below a threshold amount of data transmitted from the mobile device to the network source for a threshold time duration.

In some aspects, the techniques described herein relate to a system including: at least one processor; and at least one module executable by the at least one processor to: perform data transmission of data to a remote device; detect that a trigger condition occurs in relation to the data transmission; and transmit, based at least in part on the trigger condition, a notification to the remote device to transition to a locked state.

In some aspects, the techniques described herein relate to a system, wherein the remote device includes a mobile device, and wherein the data includes cloud computing content.

In some aspects, the techniques described herein relate to a system, wherein the trigger condition includes an indication that the data transmission falls below a threshold amount of data.

In some aspects, the techniques described herein relate to a system, wherein the trigger condition further includes an indication that the data transmission falls below the threshold amount of data for a threshold time duration.

In some aspects, the techniques described herein relate to a system, wherein the trigger condition includes an indication that data reception from the remote device falls below a threshold amount of data.

In some aspects, the techniques described herein relate to a system, wherein the trigger condition further includes an indication that the data reception falls below the threshold amount of data for a threshold time duration.

1. A mobile device comprising:
at least one processor; and
at least one module executable by the at least one processor to:
monitor data reception of data received from a network source and transmitted from the mobile device to an external display device;
detect that a trigger condition occurs in relation to the data reception; and
cause, based at least in part on the trigger condition, the mobile device to transition to a locked state.

2. The mobile device of claim 1, wherein the at least one module is executable by the at least one processor to determine that the mobile device is connected to the external display device via at least one of a wired connection or a wireless connection.

3. The mobile device of claim 1, wherein the at least one module is executable by the at least one processor to determine that the mobile device is not utilized as an input device for providing input to the data transmitted from the mobile device to the external display device.

4. The mobile device of claim 3, wherein the at least one module is executable by the at least one processor to determine that at least one input device external to the mobile device is used as an input device for providing input to the data transmitted from the mobile device to the external display device.

5. The mobile device of claim 1, wherein the at least one module is executable by the at least one processor to monitor the data reception based at least in part on whether the data reception occurs via wired connectivity or wireless connectivity to the network source.

6. The mobile device of claim 1, wherein the trigger condition comprises an indication that the data reception falls below a threshold amount of data received from the network source.

7. The mobile device of claim 6, wherein the trigger condition further comprises an indication that the data reception falls below the threshold amount of data received from the network source for a threshold time duration.

8. The mobile device of claim 7, wherein the at least one module is executable by the at least one processor to enable at least one of the threshold amount of data or the threshold time duration to be user configurable.

9. The mobile device of claim 7, wherein the at least one module is executable by the at least one processor to enable at least one of the threshold amount of data or the threshold time duration to be configured based on a location of the mobile device.

10. The mobile device of claim 1, wherein the trigger condition comprises an indication that data transmission from the mobile device to the network source falls below a threshold amount of data transmitted from the mobile device to the network source for a threshold time duration.

11. A method, comprising:
monitoring data reception of data received at a mobile device from a network source and transmitted from the mobile device to an external display device;
detecting that a trigger condition occurs in relation to the data reception; and
causing, based at least in part on the trigger condition, the mobile device to transition to a locked state.

12. The method of claim 11, wherein the trigger condition comprises an indication that the data reception falls below a threshold amount of data received from the network source for a threshold time duration.

13. The method of claim 12, wherein one or more of the threshold amount of data or the threshold time duration are least one of user configurable or based on a location of the mobile device.

14. The method of claim 11, wherein the trigger condition comprises an indication that data transmission from the mobile device to the network source falls below a threshold amount of data transmitted from the mobile device to the network source for a threshold time duration.

15. A system comprising:
at least one processor; and
at least one module executable by the at least one processor to:
perform data transmission of data to a remote device;
detect that a trigger condition occurs in relation to the data transmission; and
transmit, based at least in part on the trigger condition, a notification to the remote device to transition to a locked state.

16. The system of claim 15, wherein the remote device comprises a mobile device, and wherein the data comprises cloud computing content.

17. The system of claim 15, wherein the trigger condition comprises an indication that the data transmission falls below a threshold amount of data.

18. The system of claim 17, wherein the trigger condition further comprises an indication that the data transmission falls below the threshold amount of data for a threshold time duration.

19. The system of claim 15, wherein the trigger condition comprises an indication that data reception from the remote device falls below a threshold amount of data.

20. The system of claim 19, wherein the trigger condition further comprises an indication that the data reception falls below the threshold amount of data for a threshold time duration.
